(19) United States
(12) Patent Application Publication
(10) Pub. No.: US 2007/0258670 A1
(43) Pub. Date: Nov. 8, 2007

(54) Fluid Dynamic Pressure Bearing, Spindle Motor with the Fluid Dynamic Pressure Bearing; and Recording Disk Drive Device with the Spindle Motor

(75) Inventor: Tadashi Akahori, Kitasaku-Gun (JP)

Correspondence Address: OLIFF & BERRIDGE, PLC, P.O. BOX 19928, ALEXANDRIA, VA, 22320, US

(73) Assignee: Minebea Co., Ltd., Kitasaku-gun (JP)

(21) Appl. No.: 11/631,301

(22) PCT Filed: Aug. 12, 2005
(86) PCT No.: PCT/IB05/02419

§ 371 Date: Feb. 21, 2007

(30) Foreign Application Priority Data
Aug. 31, 2004 (JP) 2004-251739

(51) Int. Cl. F16C 32/06

(52) U.S. Cl. 384/112; 310/66; 369/176

(57) ABSTRACT

A fluid dynamic pressure bearing includes dynamic pressure grooves formed between a shaft member and a bearing member. The shaft member includes a flange portion 1-2, and a capillary seal portion 8 is formed between an outer circumferential surface of the flange portion and an inner circumferential surface of the bearing member. An annular labyrinth member 4 is engaged with an upper portion of the bearing, and a labyrinth seal portion is defined by (i) an annular protrusion 1-4 formed on an upper end surface of the flange portion and facing the labyrinth member via a micro gap and/or (ii) an annular protrusion 4-2 formed on a lower end surface of the labyrinth member and facing the flange portion via a micro gap.

### BACKGROUND

The invention of this application relates to a fluid dynamic pressure bearing that is provided with a structure that allows a recording device using a recording disk such as a magnetic disk or an optical disk to be smaller and thinner, and has an excellent function to suppress lubricant filling the fluid dynamic pressure bearing from leaking to the outside due to an external shock. The invention also relates to a spindle motor provided with the fluid dynamic pressure bearing, and a recording disk drive device with spindle motor.

Recently, recording devices that use a recording disk such as a magnetic disk or an optical disk used for a computer device, and particularly portable devices such as a notebook personal computer, have come to be widely used. Accordingly, for a spindle motor that is used for disk rotation in such devices, there are strong demands for miniaturization, thinness, and lightness. There is strong urgency in the industry to meet these demands.

Meanwhile, in the case of portable devices that can be easily carried, unlike a conventional desktop unit that is placed on a desk and used, there are many chances for vibration or an external shock to be applied during moving or handling. Therefore, there is a strong demand for improving the resistance to vibration and shock for a bearing portion, which is particularly susceptible to the effects of the vibration or shock.

Although improvements in miniaturization, thinness, and lightness have been made in terms of shape and dimension, there is a problem, from the standpoint of resistance to vibration and shock, of establishing a structure in which sufficient rigidity of a fluid dynamic pressure bearing is maintained, and in which lubricant filling the fluid dynamic pressure bearing is suppressed from splashing and leaking to the outside.

FIG. 6 shows an example of a conventional structure of a spindle motor using a fluid dynamic pressure bearing. In this spindle motor 010, a shaft member 01 is rotatably supported on a bearing member that has a sleeve 02 as a main structural element. The shaft member 01 is constituted by a shaft portion 01-1 and a flange portion 01-2 engaged with the lower end of the shaft portion 0-1. A hub 012 is engaged with an upper end of the shaft member 01. The bearing member is constituted by a sleeve 02 engaged with an inner surface of a central cylindrical portion 011-1 of a housing 011, and an end cap 05 engaged with and affixed to a lower end first large diameter portion of the sleeve 02.

By thus engaging and affixing the end cap 05 to the lower end first large diameter portion of the sleeve 02, respective micro gaps are formed between both surfaces of the flange portion 01-2 and two surfaces of counterpart members facing the both surfaces, that is, between the end surface of the lower end second large diameter portion (whose diameter is smaller than the diameter of the lower end first large diameter portion) of the sleeve 02 and the top surface of the end cap 05. The flange portion 01-2 is rotatably held so as to be sandwiched between these two surfaces. Furthermore, by so doing, the shaft member 01 is suppressed from being pulled out of the bearing member.

On the inner circumferential surface of the upper end portion of the sleeve 02, a circumferential groove for lubricant splash suppression 02-4 is formed. The micro gap between the shaft portion 01-1 facing the circumferential groove for lubricant splash suppression 02-4 and the sleeve 02 constitutes a capillary seal portion, including the circumferential groove for lubricant splash suppression 02-4. A liquid surface of lubricant 06 is formed at this capillary seal, and the capillary seal absorbs fluctuation of the liquid surface, and suppresses lubricant from splashing and leaking out of the bearing.

Radial dynamic pressure generating grooves 02-1 are formed spaced apart in an axial direction under the circumferential groove for lubricant splash suppression 02-4 on the inner circumferential surface of the sleeve 02. Additionally, an axial dynamic pressure generating groove 02-2 is formed on the end surface of the lower end second large diameter portion of the sleeve 02 facing the upper end surface of the flange portion 01-2. Furthermore, an axial dynamic pressure generating groove 05-1 is formed on the top surface of the end cap 05 facing the lower end surface of the flange portion 01-2.

The lubricant 06 continuously fills a micro gap between the bearing member, which includes the sleeve 02 and the end cap 05, and the shaft member 01, which includes the flange portion 01-2. The shaft member 01 is rotatably supported by the bearing member via a film of the lubricant 06.

FIGS. 7 and 8 show another conventional example (see Japanese Patent Application 2004-031448, of which the applicant is the same as in the present application). In this spindle motor 010′ of this conventional example, as shown in FIG. 7, a shaft member 01 in which a flange portion 01-2 is formed integrally with the upper portion of the shaft portion 01-1 is rotatably supported by a sleeve 02. The sleeve 02 is engaged with a casing 03. A micro gap between the inner circumferential surface of the sleeve 02 and the outer circumferential surface of the shaft portion 01-1 is in communication with a micro gap between the upper end surface of the sleeve 02 and the lower end surface of the flange portion 01-2. Lubricant 06 fills the micro gaps. The shaft member 01 is rotatably supported on the sleeve 02 via a film of the lubricant 06. The end cap 05 is engaged with the lower end inner circumferential surface of the casing 03, which is engaged with the sleeve 02. The bearing member is constituted by the sleeve 02, the casing 03, and the end cap 05.

On the inner circumferential surface of the sleeve 02, radial dynamic pressure generating grooves 02-1 are formed at two locations spaced apart in the axial direction. An axial dynamic pressure generating groove 02-2 is formed on the upper end surface of the sleeve 02 facing the lower end surface of the flange portion 01-2.

Furthermore, as shown enlarged in FIG. 8, a convex portion 01-6 is formed on the outer peripheral portion of the flange portion 01-2, and an L-shaped bent portion 03-3 bent inward in an L-shape is formed at the upper end portion of the casing 03. Furthermore, a capillary seal portion 08 is formed by an axial direction gap portion between the upper surface of the convex portion 01-6 and the lower surface of the L-shaped bent portion 03-3, and a diameter direction gap portion, continuous with the axial direction gap portion, between the outer circumferential surface above the convex portion 01-6 of the flange portion 01-2 and the inner circumferential surface of the L-shaped bent portion 03-3. Furthermore, the shaft member 01 is suppressed from being pulled out in axial direction by the two surfaces opposite to each other forming the axial direction gap portion.

The capillary seal portion 08 is continuous with the micro gap between the shaft member 01 and the sleeve 02. As described above, the micro gap is formed by a micro gap between the inner circumferential surface of the sleeve 02 and the outer circumferential surface of the shaft portion 01-1 and a micro gap between the upper end surface of the sleeve 02 and the lower end surface of the flange portion 01-2. The capillary seal portion 08 seals the lubricant 06 that fills the micro gap.

Attraction plates 017 fixed to the bottom surface of the housing 011 are immediately under permanent magnets 014, and if a rotor assembly body constituted by the shaft member 01 and the hub 012 is rotated within the sleeve 02, when the shaft member 01 is lifted by a dynamic pressure force generated by the axial dynamic pressure generating portion, the permanent magnets 014 are attracted in a direction opposite to the dynamic pressure force direction so that the top surface of the convex portion 01-6 of the flange portion 01-2 does not strike against the lower surface of the L-shaped bent portion 03-3 of the casing 03, and keeps an appropriate labyrinth gap t.

The structure of the conventional example shown in FIG. 7 is an improved structure in which thinness is made possible by moving the flange portion 01-2 and the end cap 05, which inhibited making the device thinner, from the lower end of the fluid dynamic pressure bearing to the upper end.

FIG. 9 shows another conventional example (see Japanese Patent Application 2004-031448, of which the applicant is the same as in the present application). In a spindle motor 010″ of this conventional example, the flange portion 01-2 and the shaft portion 01-1 shown in the conventional example of FIG. 7 are separately constituted.

### SUMMARY

However, in the conventional example shown in FIG. 6, the following problems exist in meeting the above-mentioned demand for miniaturization, thinness, and lightness.

When the spindle motor 010 is made thinner, an axial direction dimension h of the housing 011 that forms a base needs to be made smaller, i.e., thinner. However, the end cap 05 and the flange portion 01-2 are assembled with the lower end portion of the sleeve 02, so the dimension h cannot be made smaller. Additionally, the axial direction length of the radial dynamic pressure generating portion is determined by the required dynamic pressure force, so the axial direction length of the sleeve 02 cannot be made smaller, either. Due to these reasons, it is difficult to make the spindle motor 010 thinner.

Additionally, there is a problem in that the capillary seal portion having the circumferential groove for lubricant splash suppression 02-4 formed in the upper end portion of the sleeve 02 cannot stop the movement of lubricant from leaking to the outside when the lubricant 06 leaks to the bearing outer side opening portion for some reason.

In the structure shown in FIG. 7, in the same manner as the conventional example shown in FIG. 6, when the capillary seal portion 08 is broken and the lubricant 06 leaks to the outer side opening portion of the bearing, there is no double seal function or structure to suppress lubricant from moving to other portions.

Additionally, the structure of the conventional example shown in FIGS. 7 and 8 requires processing of the convex portion 01-6 of the flange portion 01-2, and requires very precise cut-out processing of the L-shaped bent portion 03-3 of the casing 03. In addition, it is difficult to obtain assembly accuracy in order to ensure an appropriate t dimension, and there are problems with productivity and cost.

In the structure shown in FIG. 9, the shaft portion 01-1 does not have the flange portion 01-2 with a large outer diameter, so a material with a small diameter can be used for manufacturing the shaft portion 01-1, the number of parts to be processed is fewer, and there are advantages in material and processing. However, because a step portion is formed in the shaft portion 01-1 in order to obtain position accuracy of the flange portion 01-2 with respect to the shaft portion 01-1, the shaft diameter d2 of the portion engaged with the flange portion 01-2 needs to be made smaller than the outer diameter dimension d1 of the dynamic pressure generating portion of the shaft portion 01-1. Therefore, the shaft portion 01-1 has less strength with respect to a bending stress or an external stress due to vibration. Particularly when the shaft portion dimension becomes smaller due to miniaturization or thinness of the spindle motor, there is a significant problem that cannot be ignored.

Other conventional examples are shown in Japanese Laid-Open Patent Application 2003-247536 (JP-A-2003-247536), Japanese Laid-Open Patent Application 2002-266878 (JP-A-2002-266878), etc. These examples do not disclose or suggest anything like the invention of this application, described below with reference to exemplary embodiments.

Exemplary embodiments of invention of this application resolve any or all of the above-mentioned problems that occur with conventional fluid dynamic pressure bearings. Objects of this exemplary embodiments invention are to provide a fluid dynamic pressure bearing that is provided with a structure in which the spindle motor is easily made smaller and thinner, and in which shaft rigidity can be maintained when the device is made smaller and thinner; to improve reliability of a lubricant leakage suppression mechanism; and to accomplish these objects at a lower cost without losing productivity. It is also an object to provide a spindle motor provided with the fluid dynamic pressure bearing, and a recording disk drive device provided with the spindle motor.

To address any or all of the above-mentioned problems, exemplary embodiments of the invention provide a fluid dynamic pressure bearing that includes a shaft member and a bearing member supported such that relative rotation is enabled between the shaft member and the bearing member, a micro gap being defined between the shaft member and the bearing member and containing lubricant. The shaft member includes a flange portion, and a capillary seal portion is formed between an outer circumferential surface of the flange portion and an inner circumferential surface of the bearing member. The capillary seal portion includes a circumferential groove for lubricant splash suppression, formed on (i) an outer circumferential surface of the flange portion and/or (ii) a surface of the bearing opposing the outer circumferential surface of the flange portion. An annular labyrinth member is engaged with an upper portion of the bearing, and a labyrinth seal portion is defined by (i) an annular protrusion formed on an upper end surface of the flange portion and facing the labyrinth member via a micro gap and/or (ii) an annular protrusion formed on a lower end surface of the labyrinth member and facing the flange portion via a micro gap. A dynamic pressure groove that generates a dynamic pressure that receives a load in a radial direction is formed on either an outer circumferential surface of the shaft or an inner circumferential surface of the bearing member. A dynamic pressure groove that generates a dynamic pressure that receives a load in an axial direction is formed on either the upper end surface of the bearing member that faces the lower end surface of the flange portion, or the lower end surface of the flange portion.

With the structure described above, a function of lubricant splash and leakage suppression is given by two portions, that is, the capillary seal portion and the labyrinth seal portion, so highly reliable lubricant splash and leakage suppression can be obtained by a double seal function because of these two portions. Furthermore, these two portions are formed at locations directly facing the outer circumferential surface and the upper end surface of the flange portion, so the axial direction dimension of the fluid dynamic pressure bearing is reduced, and miniaturization and thinness of the spindle motor become easy.

In particular, the labyrinth seal portion is formed as the annular protrusion formed on the flange portion faces the labyrinth member via a micro gap and the annular protrusion formed on the labyrinth member faces the flange portion via a micro gap. Therefore, this makes a double stage labyrinth seal and improves the effect of the lubricant splash and leakage suppression. In addition, in this case, a space is formed between the two annular protrusions, and the space becomes an oil retention portion. Therefore, this further improves the effect of the lubricant splash and leakage suppression. At the same time, this labyrinth seal portion is used as a pull-out suppression portion to suppress the shaft member from being pulled out the axial direction outer opening side, and the effect of pull-out suppression on the shaft member also can be improved.

Additionally, the flange portion is moved to the upper end of the sleeve, and there is no need for forming an axial dynamic pressure generating groove in the end cap. Thus, the end cap can be made thinner. From this perspective as well, the axial direction dimension of the fluid dynamic pressure bearing can be made smaller. In addition, as the radial dynamic pressure bearing portion approaches the center, in the axial direction, of the housing, the problem is also solved in which a hub in a spindle motor becomes thick. Furthermore, the spindle motor is thus made thinner, and by using the thinner spindle motor, manufacturing of a thinner recording disk drive device is also possible.

Furthermore, if the shaft portion and the flange portion of the shaft member are formed integrally, a step portion for positioning the flange portion does not need to be formed in the shaft portion, as must be done when they are separately formed. Therefore, the outer diameter dimension of the upper end of the shaft portion (the portion outward from the flange portion in the axial direction) can be made larger than the outer diameter dimension of the portion engaged with the sleeve (the portion inward from the flange portion in the axial direction). Thus, shaft rigidity can be increased, and the assembly strength can be improved when a rotation element such as a hub or the like is assembled to the upper end portion of the shaft portion. Therefore, even if the shaft member has a smaller dimension due to miniaturization, resistance to vibration and shock can easily be obtained.

In addition, the casing can be made to be a straight cylindrical shape, so press processing and extrusion processing are possible, productivity is improved, and cost reduction can be improved.

If the annular protrusion formed on the labyrinth member is omitted, i.e., if the labyrinth seal portion is defined by only the annular protrusion formed on the upper end surface of the flange portion, then a double labyrinth seal function is not expected, and a space is not formed between double labyrinth seal stages. Therefore, the effect of lubricant splash and leakage suppression due to a labyrinth seal is slightly deteriorated compared to the case when both annular protrusions are used, but other effects are the same. If the annular protrusion formed on the labyrinth member is omitted, the labyrinth member can be easily processed by press processing or the like. When vibration or an external shock is not significant, and there is a low possibility of lubricant splashing or leaking, or when another simple labyrinth function that reliably increases safety is to be added, this structure is preferable, and there is a cost advantage.

Similarly, if the annular protrusion formed on the flange portion is omitted, i.e., if the labyrinth seal portion is defined by only the annular protrusion formed on the lower end surface of the labyrinth member, then a double labyrinth seal function is not expected, and a space is not formed between double labyrinth seal stages. Thus, the effect of lubricant splash and leakage suppression due to two stages of labyrinth seal is slightly deteriorated compared to the case when both annular protrusions are used, but other effects are the same. Particularly when vibration or an external shock is not significant, and there is a low possibility of lubricant splashing or leaking, this structure is preferable. There is also another advantage in that the annular labyrinth member is not initially mounted and can be added later. This also improves cost reduction.

Furthermore, an outer diameter dimension of the shaft member outward from the flange portion in the axial direction may be larger than or identical to an outer diameter dimension of the shaft member inward from the flange portion in the axial direction.

Thus, shaft rigidity of the shaft member can be increased, and the assembly strength can be improved when a rotation element such as a hub or the like is assembled to the upper end portion of the shaft portion. Therefore, even if the shaft member has a smaller dimension due to miniaturization, resistance to vibration and shock can easily be obtained.

Furthermore, the bearing member may include a sleeve that is engaged with the shaft member, a casing that holds the sleeve, and an end cap engaged with a lower end portion of the casing. The labyrinth member may be engaged with an upper portion of the casing. On an outer circumferential surface of the sleeve, one or a plurality of lubricant communicating through-grooves may be formed extending in an axial direction of the sleeve.

Thus, one or a plurality of lubricant communicating through-holes may be defined by (i) one or a plurality of lubricant communicating through-grooves formed along the axial direction on the outer circumferential surface of the sleeve and (ii) the inner circumferential surface of the casing. The problem is solved in which, when the diameter of the sleeve is made smaller, it is extremely difficult to perform processing of one or a plurality of through-holes between the end faces of the sleeve. The processing is also easy, so from this perspective as well, productivity is improved, and cost reduction also can be improved.

Furthermore, an annular space may be formed between an inner circumferential surface of the labyrinth member and an outer circumferential surface of the shaft member. A lower portion of a boss portion of a rotation element engaged with the upper end portion of the shaft portion may go through the space, and the lower end of the rotation element can contact the upper end surface of the flange portion.

Thus, the upper end surface of the flange portion of the shaft member can be used as a surface that abuts against the lower end of a rotation element such as a boss portion. Thus, accuracy of assembling a rotation element such as a hub or the like to the shaft member can be easily obtained.

In another aspect, the invention provides a spindle motor including the fluid dynamic pressure bearing as described above, a stator that is fixed to a housing, a rotor that is provided with a rotor hub that forms a rotation element engaged with an upper end portion of the shaft portion, and a rotor magnet that is engaged with the rotor hub and generates a rotation magnetic field in cooperation with the stator, and is rotatably arranged with respect to the housing. The fluid dynamic pressure bearing device supports rotation of the rotor, and the rotor is attracted by a magnetic force in a direction opposite to a direction of a dynamic pressure generated by a dynamic pressure groove for generating a dynamic pressure that receives a load in an axial direction within the fluid dynamic pressure bearing. The load is supported by balancing the dynamic pressure and the magnetic force.

With this structure, leakage or splash of lubricant from the fluid dynamic pressure bearing to the outside can be suppressed, and motor contamination due to lubricant splash does not occur. Therefore, a spindle motor with high reliability can be provided at a lower cost without losing productivity.

In another aspect, the invention provides a recording disk drive device provided with the spindle motor as described above, and a recording head that writes and/or reads information with respect to a recording disk. The spindle motor rotatingly drives the recording disk.

With this structure, leakage or splash of lubricant from the fluid dynamic pressure bearing to the outside can be suppressed, and device contamination due to lubricant splash does not occur. Therefore, a recording disk drive device with high reliability can be provided at a lower cost without losing productivity.

Additionally, the labyrinth seal portion formed of two labyrinth seals can be made into one stage or two stages or more, depending on the magnitude of external shock. When the labyrinth seal portion is made to be formed of two stages or more, the effects of the lubricant splash and leakage suppression can be further improved.

These and other features, objects and/or advantages are described in or apparent from the following detailed description of exemplary embodiments.

### BRIEF DESCRIPTION OF THE DRAWINGS

Exemplary embodiments are described with references to the accompanying drawings, in which like numerals represent like parts, and in which:

FIG. 1 is a cross-sectional view of a fluid dynamic pressure bearing of a first embodiment (embodiment 1) of the invention of this application;

FIG. 2 is a cross-sectional view of a fluid dynamic pressure bearing of a second embodiment (embodiment 2) of the invention of this application;

FIG. 3 is a cross-sectional view of a fluid dynamic pressure bearing of a third embodiment (embodiment 3) of the invention of this application;

FIG. 4 is a vertical cross-sectional view of a spindle motor to which the fluid dynamic pressure bearing of embodiment 1 is applied;

FIG. 5 is a vertical cross-sectional view of a hard disk drive device provided with a spindle motor to which the fluid dynamic pressure bearing of embodiment 1 is applied;

FIG. 6 is a vertical cross-sectional view of a conventional fluid dynamic pressure bearing;

FIG. 7 is a vertical cross-sectional view of another conventional fluid dynamic pressure bearing;

FIG. 8 is an enlarged view of a portion of FIG. 7; and

FIG. 9 is a vertical cross-sectional view of another conventional fluid dynamic pressure bearing.

### DETAILED DESCRIPTION OF EMBODIMENTS

### Embodiment 1

The following explains a first embodiment (embodiment 1) of the invention of this application.

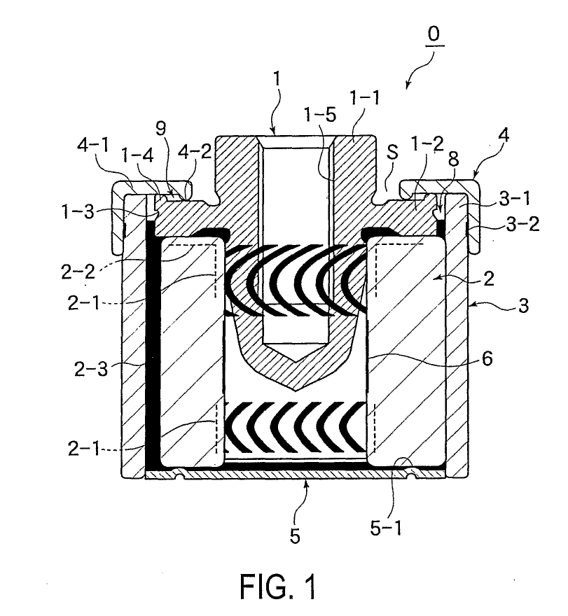

FIG. 1 is a cross-sectional view of a fluid dynamic pressure bearing of embodiment 1. In the fluid dynamic pressure bearing 0, a shaft member 1 is engaged with a sleeve 2 that is engaged with an inner circumferential surface of a casing 3, and is rotatable relative to the casing 3. The shaft member 1 is constituted by a shaft portion 1-1 and a flange portion 1-2 that is integral with the shaft portion 1-1 at an upper end of the shaft portion 1-1. For example, the shaft portion 1-1 and the flange portion 1-2 may be formed integrally from a single piece of material. The outer peripheral portion of an end cap 5 is engaged with and affixed to the inner circumferential surface of the lower end portion of the casing 3, and a cup-shaped bearing member is constituted by the sleeve 2, the casing 3, the end cap 5, and a labyrinth member 4. The labyrinth member 4 will be described hereafter. On the upper surface of the end cap 5, a plurality of protrusions 5-1 are formed. The protrusions 5-1 contact the lower end surface of the sleeve 2, whereby a micro gap is formed between the lower end surface of the sleeve 2 and the upper surface of the end cap 5.

On the inner circumferential surface of the sleeve 2, radial dynamic pressure generating grooves 2-1 are formed at two locations spaced apart in the axial direction. On the upper end surface of the sleeve 2 facing the lower end surface of the flange portion 1-2, an axial dynamic pressure generating groove 2-2 is formed.

The grooves 2-1 and 2-2 may have a shape currently known in the art in the context of dynamic pressure generating grooves, or any later-developed shape. These dynamic pressure generating grooves respectively generate dynamic pressures to receive loads in the radial direction and the axial direction within lubricant that fills the micro gap between the shaft member 1 and the sleeve 2. Therefore, a radial dynamic pressure generating portion and an axial dynamic pressure generating portion are respectively formed by the dynamic pressure generating grooves and the micro gap portions facing the dynamic pressure generating grooves. It is also acceptable for the dynamic pressure generating grooves to be arranged on the outer circumferential surface of the opposing shaft portion 1-1 and the lower end surface of the flange portion 1-2.

On the outer circumferential surface of the flange portion 1-2, a circumferential groove for lubricant splash suppression 1-3 is formed. In the gap portion between the inner circumferential surface of an annular extension 3-1 that extends upward from the upper end surface of the sleeve 2 of the casing 3 and the outer circumferential surface of the flange portion 1-2, a capillary seal portion 8 is formed. The circumferential groove for lubricant splash suppression 1-3 forms part of the capillary seal portion 8, and forms a lubricant retention portion and suppresses liquid surface fluctuation of the lubricant, whereby the lubricant is suppressed from splashing and leaking to the bearing outer opening portion. Furthermore, at the outer peripheral portion of the upper end surface of the flange portion 1-2, an annular protrusion 1-4 is formed so as to protrude upward.

An annular labyrinth member 4 is engaged with the extension 3-1 of the top portion of the casing 3. This labyrinth member 4 may be fixed by, for example, adhesive injected in a circumferential groove 3-2 formed in the outer circumferential surface of the top portion of the casing 3. In this embodiment, the labyrinth member 4 has a substantially L-shaped cross section and includes a bent flat portion 4-1 that forms a flat wall portion bent inward and facing the flange portion 1-2. At the inner peripheral portion of the labyrinth member 4, an annular protrusion 4-2 is formed so as to protrude downward.

The protruding surface of the annular protrusion 1-4 and the bent flat portion 4-1 face each other via a gap that is equal to an amount that the shaft member 1 floats up during rotation of the shaft member 1 plus a micro gap amount. In the same manner, the convex surface of the annular protrusion 4-2 and the top end surface of the flange portion 1-2 face each other via a gap that is equal to an amount that the shaft member 1 floats up during rotation of the shaft member 1 plus a micro gap amount. The surfaces are thus arranged facing each other in the respective locations, so a labyrinth seal portion 9 formed of two stages of labyrinth seal is formed. This labyrinth seal portion 9 absorbs energy of lubricant that tries to splash and leak to the bearing outer opening portion side from the capillary seal portion 8, and suppresses the leakage. At the same time, the labyrinth seal portion 9 plays a role of suppressing the shaft member 1 from being pulled out of the bearing member.

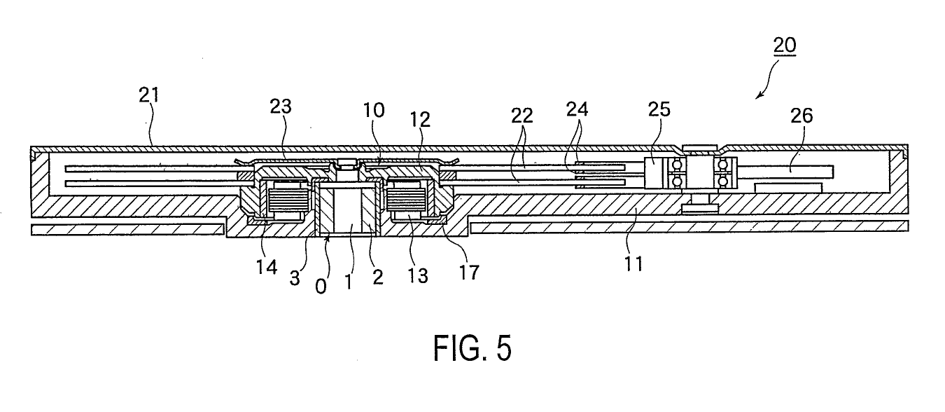

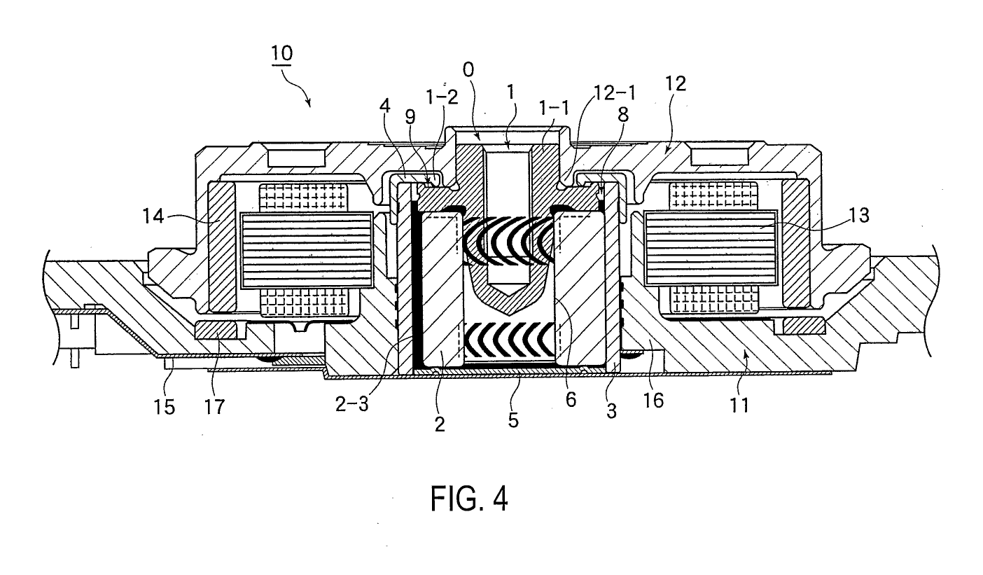

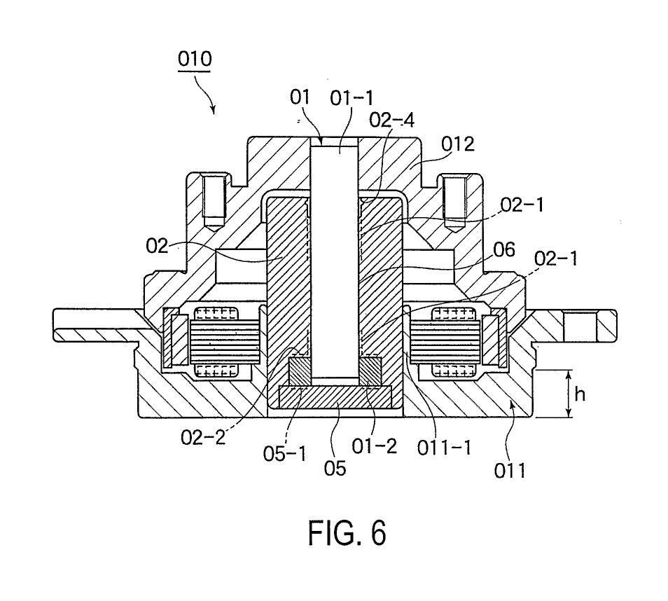

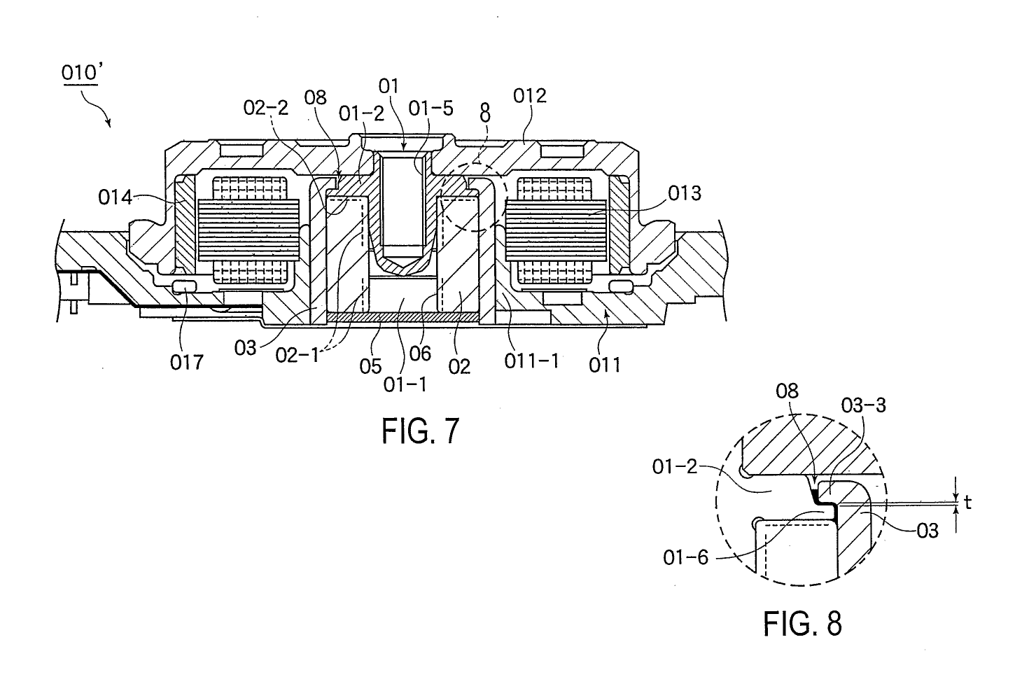

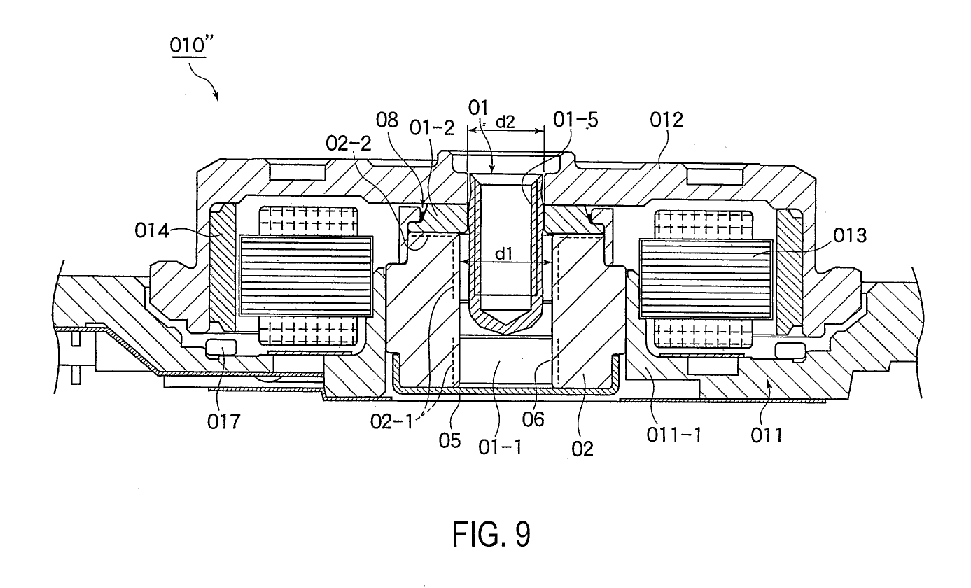

An annular space S is formed between the inner peripheral portion of the labyrinth member 4 and the shaft portion 1-1 of the shaft member 1. A lower portion of a boss portion 12-1 of a later-described rotor hub 12 that engages with the upper end portion of the shaft portion 1-1 goes through this space S. Furthermore, the lower end of the boss portion 12-1 contacts the inner peripheral portion of the upper end surface of the flange portion 1-2 (see FIG. 4). Thus, when the rotor hub 12 is engaged with the shaft portion 1-1, assembly precision can be easily obtained.

On the outer circumferential surface of the sleeve 2, a through-groove 2-3 is formed in one or a plurality of locations, extending in the axial direction. The through-groove 2-3 is covered by the inner circumferential surface of the casing 3, so a through-hole is formed. The micro gap between the shaft member 1 and the sleeve 2, the micro gap between the sleeve 2 and the end cap 5, which is formed by the protrusions 5-1 of the end cap 5 contacting the lower end surface of the sleeve 2, the micro gap between the lower end surface of the shaft member 1 and the end cap 5, the through-hole, and the capillary seal portion 8 are in communication with each other, and contain the lubricant 6.

With respect to the shaft portion 1-1 of the shaft member 1, the outer diameter dimension of the portion that is axially outward from the flange portion 1-2 is larger than the outer diameter dimension of the portion that is axially inward from the flange portion 1-2 (the portion engaged with the sleeve 2). Because of this, shaft rigidity of particularly the portion of the shaft portion 1-1 that is axially outward from the flange portion 1-2 (the upper end portion of the shaft portion 1-1) can be increased. Furthermore, assembly strength can be improved when a rotation element such as the later-mentioned rotor hub 12, etc. is assembled to the upper end portion of the shaft portion 1-1.

FIG. 4 is a vertical cross-sectional view of a spindle motor to which the fluid dynamic pressure bearing of embodiment 1 is applied. In this figure, a spindle motor 10 constitutes a shaft rotation-type spindle motor, and the casing 3 of a fluid dynamic pressure bearing 0 is engaged with a hole that goes through a boss portion 16 of a housing 11. The boss portion 16 is formed so as to protrude upward from a bottom portion of the housing 11 in a substantially central position of the bottom portion, in FIG. 4. A boss portion 12-1 of a rotor hub 12 that forms a rotation element of this motor is engaged with the upper end portion of the shaft portion 1-1 of the shaft member 1 of the fluid dynamic pressure bearing 0. This rotor hub 12 is rotated integrally with the shaft member 1. A plurality of information recording media (recording disks) such as undepicted magnetic disks, optical disks, etc. are mounted in layers to the outer circumferential surface of the rotor hub 12. A tap hole 1-5 (see FIG. 1) formed inside of the upper end portion of the shaft portion 1-1 is used to affix a clamp member, which pressingly fixes the information recording media from above, to the shaft portion 1-1.

A stator 13 in which coils are wound around a stator core is engaged with the outer circumferential surface of the boss portion 16 of the housing 11. Spaced slightly from the stator 13 in the diameter direction, permanent magnets 14 engaged with a shield yoke are arranged in a circumferential direction so as to surround the stator 13, and are mounted to the inner circumferential surface of the circumferential wall of the rotor hub 12. A flexible wiring substrate 15 may be fixed to the lower surface of the housing 11, and as a control electric current is supplied to the stator 13 from an output terminal of the wiring substrate 15, a rotor assembly formed of the permanent magnets 14, the rotor hub 12 and the shaft member 1 begins to rotate with respect to the stator 13.

Annular attraction plates 17 fixed to the bottom surface of the housing 11 immediately under the permanent magnets 14 attract the permanent magnets 14. When the shaft member 1 is lifted by a dynamic pressure force generated by the axial dynamic pressure generating portion due to the rotation of the rotor assembly body, the permanent magnets 14 are attracted in the direction opposite to the dynamic pressure force direction so that the protruding surface of the annular protrusion 1-4 of the flange portion 1-2 does not strike against the inner flat surface of the labyrinth member 4 and an appropriate labyrinth gap is maintained.

FIG. 5 is a vertical cross-sectional view of a hard disk drive device provided with a spindle motor to which the fluid dynamic pressure bearing of embodiment 1 is applied.

As shown in FIG. 5, a hard disk drive device 20 is constituted by the spindle motor 10, a housing 11, a cover member 21 that seals the space within the housing 11 and forms a clean space with extremely little dust, hard disks 22, a clamp member 23 that clamps the hard disks 22, recording heads 24 that write and/or read information with respect to the hard disks 22, an arm 25 that supports the recording heads 24, and a voice coil motor 26 that moves the recording heads 24 and the arm 25 to a predetermined position. Two hard disks 22 are mounted on the rotor hub 12, but the number of hard disks is not limited to this. The hard disks 22 are rotated along with rotation of the rotor hub 12.

Pairs of upper and lower recording heads 24 are fixed to the tip end portions of head stack assemblies fixed to the arm 25, which is rotatably supported with respect to an appropriate location of the bottom portion of the housing 11. These pairs of upper and lower recording heads 24 are each arranged so as to sandwich one hard disk 22, and to write and/or read information with respect to both surfaces of the respective hard disk 22. In this magnetic disk drive device 20, two magnetic disks 22 are constituted, and two pairs of recording heads 24 are arranged.

Thus, the spindle motor 10 provided with the fluid dynamic pressure bearing 0 of embodiment 1 is used as a spindle motor of the hard disk drive device 20. Therefore, leakage or splash of lubricant from the fluid dynamic pressure bearing 0 to the outside can be suppressed, and motor and device contamination due to lubricant splash does not occur. Therefore, the spindle motor 10 and the hard disk drive device 20 with high reliability can be provided at a lower cost without losing productivity.

Furthermore, in this example, the spindle motor 10 provided with the fluid dynamic pressure bearing 0 of embodiment 1 is applied to the hard disk drive device 20. However, instead of the hard disks 22, a recording disk such as a CD or DVD can be used, and the spindle motor 10 can also be used for a recording disk drive device that drives these recording disks.

Because embodiment 1 is thus construed, the following effects can be given.

The function of lubricant splash and leakage suppression is given by two portions, that is, the capillary seal portion 8 and the labyrinth seal portion 9, so lubricant splash and leakage suppression with high reliability can be obtained by a double seal function because of these two portions. Furthermore, these two portions are formed at locations directly facing the outer circumferential surface and the upper end surface of the flange portion 1-2, so the axial direction dimension of the fluid dynamic pressure bearing 0 is reduced, and miniaturization and thinness of the spindle motor become easy.

In particular, the labyrinth seal portion 9 is formed as a convex surface of the annular protrusion 1-4 formed on the flange portion 1-2 faces the lower end surface of the labyrinth member 4 via a micro gap and the convex surface of the annular protrusion 4-2 formed on the labyrinth member 4 faces the upper end surface of the flange portion 1-2 via a micro gap. Therefore, this makes a double labyrinth seal and improves the effects of lubricant splash and leakage suppression. In addition, in this case, a space is formed between the annular protrusion 1-4 and the annular protrusion 4-2, and the space becomes an oil retention portion. Therefore, this further improves the effects of lubricant splash and leakage suppression.

At the same time, this labyrinth seal portion 9 is used as a pull-out suppression portion to suppress the shaft member 1 from being pulled out in the axial direction toward the outer opening, and the effect of pull-out suppression on the shaft member also can be improved.

Additionally, the flange portion 1-2 is located at the upper end of the sleeve 2, and there is no need for forming an axial dynamic pressure generating groove in the end cap 5. Thus, the end cap 5 can be made thinner. From this perspective as well, the axial direction dimension of the fluid dynamic pressure bearing 0 can be made smaller. In addition, because the radial dynamic pressure bearing portion approaches the center, in the axial direction, of the housing 11, the problem is also solved in which the rotor hub 12 of the spindle motor 10 becomes thick. Furthermore, the spindle motor 10 is thus made thinner, and by using the thinner spindle motor 10, manufacturing of a thinner recording disk drive device is also possible.

Furthermore, in the shaft member 1, the shaft portion (shaft member main body portion) 1-1 and the flange portion 1-2 may be formed integrally, in which case there is no need to form a positioning step in the shaft portion for positioning the flange portion, as must be done when the shaft portion 1-1 and the flange portion 1-2 are separately formed. Therefore, the outer diameter dimension of the upper end of the shaft portion 1-1 (the part outward from the flange portion 1-2 in the axial direction) can be made larger than the outer diameter dimension of the part engaged with the sleeve (the part inward from the flange portion 1-2 in the axial direction). Thus, shaft rigidity can be increased, and the assembly strength can be improved when the rotor hub 12 is assembled to the upper end portion of the shaft portion 1-1. Therefore, even if the shaft member 1 has a smaller dimension due to miniaturization, resistance to vibration and shock can be easily obtained.

In addition, because the casing 3 can be made in a straight cylindrical shape, press processing and extrusion processing are possible, productivity is improved, and cost reduction can be improved.

Furthermore, on the outer circumferential surface of the sleeve 2, one or a plurality of lubricant through-grooves 2-3 are formed along the axial direction. Therefore, one or a plurality of lubricant through-holes are formed by the through-grooves and the inner circumferential surface of the casing. The problem is solved in which when the diameter of the sleeve 2 is made smaller, it is extremely difficult to perform processing of one or a plurality of through-holes within the sleeve 2. Also, because the processing is easy, productivity is improved from this perspective as well, and cost reduction also can be improved.

Furthermore, an annular space S is formed between the inner peripheral portion of the labyrinth member 4 and the shaft portion 1-1 of the shaft member 1, and the lower portion of the boss portion 12-1 of the rotor hub 12 engaged with the upper end portion of the shaft portion 1-1 goes through the space S, and the lower end of the boss portion 12-1 contacts the upper end surface of the flange portion 1-2. Therefore, because the upper end surface of the flange portion 1-2 can be used as a surface that abuts against the lower end of the boss portion 12-1, accuracy in assembling the rotor hub 12 to the shaft member 1 can be easily obtained.

Furthermore, in the spindle motor 10 provided with the fluid dynamic pressure bearing 0 of embodiment 1 and the recording disk drive device 20 provided with the spindle motor 10, leakage or splash of lubricant from the fluid dynamic pressure bearing 0 to the outside can be suppressed, and motor and device contamination due to lubricant splash does not occur. Therefore, the spindle motor 10 and the recording disk drive device 20 with high reliability can be provided at a lower cost without losing productivity.

### Embodiment 2

The following explains a second embodiment (embodiment 2) of the invention of this application.

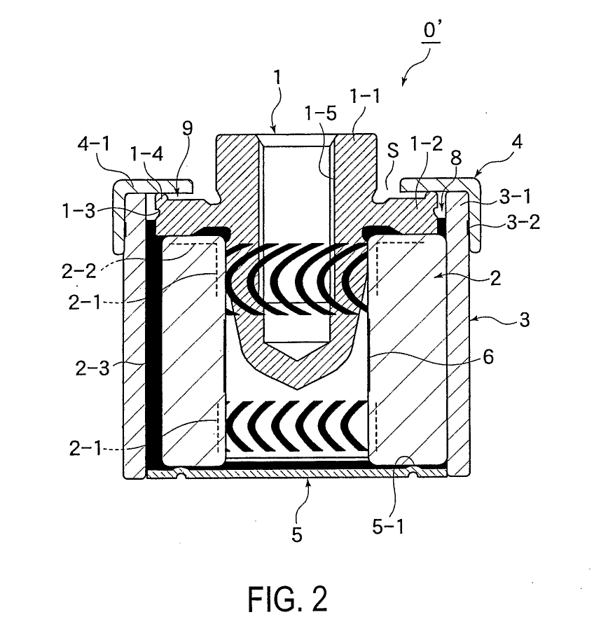

FIG. 2 is a cross-sectional view of a fluid dynamic pressure bearing of embodiment 2. The difference between the fluid dynamic pressure bearing 0′ of embodiment 2 and the fluid dynamic pressure bearing 0 of embodiment 1 is that, in the fluid dynamic pressure bearing 0′ of embodiment 2, the annular protrusion 4-2 formed on the labyrinth member 4 in the fluid dynamic pressure bearing 0 of embodiment 1 is omitted.

Because the fluid dynamic pressure bearing 0′ of embodiment 2 is thus constituted, a double labyrinth seal function is not provided, and a space is not formed between double labyrinth seal stages. Therefore, the lubricant splash and leakage suppression effect of the labyrinth seal is slightly deteriorated compared to the fluid dynamic pressure bearing 0 of embodiment 1. However, other effects are the same as those of the invention of embodiment 1. When the annular protrusion 4-2 is omitted, the labyrinth member 4 can be easily processed by press processing or the like. When vibration or external shock is not significant, and there is a low possibility of lubricant splashing or leaking, or when it is desired to add a simple labyrinth function that reliably increases safety, the fluid dynamic pressure bearing 0′ of embodiment 2 is preferable, and there is a cost advantage.

### Embodiment 3

The following explains a third embodiment (embodiment 3) of the invention of this application.

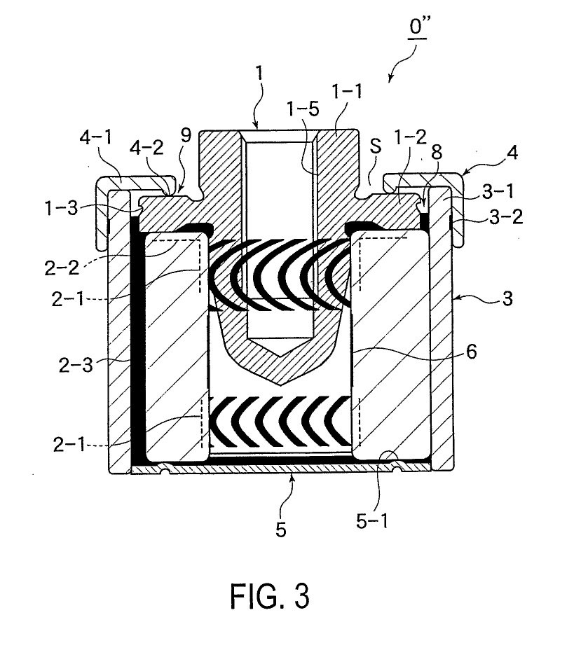

FIG. 3 is a cross-sectional view of a fluid dynamic pressure bearing of embodiment 3. The difference between the fluid dynamic pressure bearing 0″ of embodiment 3 and the fluid dynamic pressure bearing 0 of embodiment 1 is that, in the fluid dynamic pressure bearing 0″ of embodiment 3, the annular protrusion 1-4 formed on the flange portion 1-2 in the fluid dynamic pressure bearing 0 of embodiment 1 is omitted.

Because the fluid dynamic pressure bearing 0″ of embodiment 3 is thus constituted, a double labyrinth seal function is not provided, and a space is not formed between double labyrinth seal stages. Thus, the lubricant splash and leakage suppression effect of the labyrinth seal is slightly deteriorated compared to the fluid dynamic pressure bearing 0 of embodiment 1, but other effects are the same. Particularly when vibration or an external shock is not significant, and there is a low possibility of lubricant splashing or leaking, the fluid dynamic pressure bearing 0″ of embodiment 3 is preferable. There is also another advantage in that the labyrinth member 4 is not initially mounted and can be added later, which is also a cost advantage.

The invention of this application is not limited to the specific embodiments described above. Various changes, substitutes and improvements are possible within the spirit and scope of the invention.

For example, in the above-mentioned embodiments 1-3, the number of labyrinth seal stages is one or two, but by increasing the number of stages depending on the magnitude of vibration or external shock, the reliability of lubricant splash and leakage suppression can be further improved.

1. A fluid dynamic pressure bearing, comprising:
a shaft member and a bearing member supported such that relative rotation is enabled between the shaft member and the bearing member, a micro gap being defined between the shaft member and the bearing member and containing lubricant, wherein:
the shaft member includes a flange portion;
a capillary seal portion is formed between an outer circumferential surface of the flange portion and an inner circumferential surface of the bearing member;
the capillary seal portion includes a circumferential groove for lubricant splash suppression, formed on (i) an outer circumferential surface of the flange portion and/or (ii) a surface of the bearing opposing the outer circumferential surface of the flange portion;
an annular labyrinth member is engaged with an upper portion of the bearing, the annular labyrinth member being spaced from an upper end of the flange portion by a separation gap, a labyrinth seal portion being defined by (i) an annular protrusion formed on the upper end surface of the flange portion and facing the labyrinth member via a micro gap that is smaller than the separation gap and/or (ii) an annular protrusion formed on a lower end surface of the labyrinth member and facing the flange portion via a micro gap that is smaller than the separation gap;
a dynamic pressure groove that generates a dynamic pressure that receives a load in a radial direction is formed on either an outer circumferential surface of the shaft or an inner circumferential of the bearing member; and
a dynamic pressure groove that generates a dynamic pressure that receives a load in an axial direction is formed on either the upper end surface of the bearing member that faces the lower end surface of the flange portion, or the lower end surface of the flange portion.

2. The fluid dynamic pressure bearing as set forth in claim 1, wherein the labyrinth seal portion is defined by only the annular protrusion formed on the upper end surface of the flange portion.

3. The fluid dynamic pressure bearing as set forth in claim 1, wherein the labyrinth seal portion is defined by only the annular protrusion formed on the lower end surface of the labyrinth member.

4. The fluid dynamic pressure bearing as set forth in claim 1, wherein the labyrinth seal portion is defined by both (i) the annular protrusion formed on the upper end surface of the flange portion and (ii) the annular protrusion formed on the lower end surface of the labyrinth member.

5. The fluid dynamic pressure bearing as set forth in claim 1, wherein the flange portion is formed integrally with the shaft member.

6. The fluid dynamic pressure bearing as set forth in claim 1, wherein the dynamic pressure groove that generates a dynamic pressure that receives a load in the axial direction is formed on the upper end surface of the bearing member.

7. The fluid dynamic pressure bearing as set forth in claim 1, wherein an outer diameter dimension of the shaft member outward from the flange portion in the axial direction is larger than or identical to an outer diameter dimension of the shaft member inward from the flange portion in the axial direction.

8. The fluid dynamic pressure bearing as set forth in claim 1, wherein the labyrinth member is L-shaped in cross section.

9. The fluid dynamic pressure bearing as set forth in claim 1, the bearing member further comprising:
a sleeve that is engaged with the shaft member;
a casing that holds the sleeve, the labyrinth member being engaged with an upper portion of the casing; and
an end cap engaged with a lower end portion of the casing, wherein:
on an outer circumferential surface of the sleeve, one or a plurality of lubricant through-grooves are formed extending in an axial direction of the sleeve.

10. The fluid dynamic pressure bearing as set forth in claim 1, wherein:
an annular space is formed between an inner circumferential surface of the labyrinth member and an outer circumferential surface of the shaft member; and
a lower portion of a boss portion of a rotation element that engages with the upper end portion of the shaft member goes through the annular space, and a lower end of the boss portion can contact the upper end surface of the flange portion.

11. A spindle motor provided with the fluid dynamic pressure bearing as set forth in claim 1, comprising:
a stator that is fixed to a housing;
a rotor that is provided with a rotor hub that forms a rotation element engaged with an upper end portion of the shaft member and a rotor magnet that is engaged with the rotor hub and generates a rotation magnetic field in cooperation with the stator, and is rotatably arranged with respect to the housing; wherein:
the fluid dynamic pressure bearing device supports rotation of the rotor; and
the rotor is attracted by a magnetic force in a direction opposite to a direction of a dynamic pressure generated by a dynamic pressure groove for generating a dynamic pressure that receives a load in an axial direction within the fluid dynamic pressure bearing, and the load is supported by balancing the dynamic pressure and the magnetic force.

12. A recording disk drive device provided with the spindle motor as set forth in claim 11, comprising:
a recording head that writes and/or reads information with respect to a recording disk;
wherein the spindle motor rotatingly drives the recording disk.
